(19) United States
(12) Patent Application Publication
(10) Pub. No.: US 2026/0219087 A1
(43) Pub. Date: Jul. 30, 2026

(54) Flow Meter Communication Device Interface and Interaction System and Method

(71) Applicant: Badger Meter, Inc., Milwaukee, WI (US)

(72) Inventor: Jens Drachmann, Viby J (DK)

(21) Appl. No.: 19/036,710

(22) Filed: Jan. 24, 2025

(51) Int. Cl. G01F 15/063

(52) U.S. Cl. CPC G01F 15/063

(57) ABSTRACT

A utility meter assembly is configured to include a utility measurement device providing measurement of the utility provided including a utility measurement power source, utility measurement electronics, a utility measurement transceiver configured for a local area network communication, and a flow measurement housing encapsulating the components of the utility measurement device. The assembly further includes a communication endpoint including a communication endpoint power source, communication endpoint electronics, a communication endpoint transceiver configured for both of local area network communication and wide area network communication, and a communication endpoint housing encapsulating the components of the communication endpoint. The assembly is configured wherein interaction between the utility measurement device and the communication endpoint is exclusively radio communication using the local area network.

### FIELD OF THE INVENTION

This application relates to utility metering devices and associated communication endpoints configured for wireless communication in a fixed arrangement. More specifically, the invention provides a metrology device that is physically connectable in an isolation arrangement with an associated communication endpoint.

### BACKGROUND

Electronic utility meters typically are configured to include long range communication built into the electronics box together with the metrology electronics, either as a module or on the same printed circuit board. However, this configuration may be suboptimal for wireless communication reporting measured metering data in some installations and/or meter use cases. For example, where the utility meter is a water meter in a pit enclosure external to a domicile, the earth surrounding the pit enclosure and/or water flooding the pit enclosure may interfere with or even block wireless communication from the utility meter.

Built-in communication modules may also be suboptimal for additional reasons. Integrated transmission electronics add production complexity since the choice of long-range communication endpoint must be chosen before final assembly and testing of the utility meter. Accordingly, the utility meters are less flexible and more quickly dated as communication technology improves and protocols change over time.

To address this issue, in some alternative embodiments, an electronic utility meter including the metrology device is separated from a communication endpoint but includes a wired connection between the electronic utility meter and the external communication endpoint. However, the wired solution is vulnerable to accidental or deliberate disconnection. Yet further, a wired implementation requires introduction of additional potential points of failure at the wiring ingress/egress or wire connection points that increase the risk of leaks damaging the interior electronics in the electronic utility meter and/or the external communication endpoint. Yet even further, using a wired solution has the disadvantage that different meter/endpoint combinations with different cable lengths must be produced, adding to the complexity of production/stock handling.

What is needed is a utility metering device that facilitates a modular implementation of utility meter physical and communicative interoperation. What is further needed is such a utility metering device configured to provide independent housing and power systems to facilitate replacement of components while facilitating improvements to the operation of components.

### SUMMARY OF THE INVENTION

This invention is directed to a flow meter configured such that the design and production of the metrology unit is simpler and further is independent of the choice of a long-range communication. Production is improved by providing a releasable attachment point between a utility measurement device and an associated communication endpoint.

The present invention is directed to a utility meter assembly including a utility measurement device providing measurement of the utility provided including a flow measurement power source, flow measurement electronics, a flow measurement transceiver configured for a local area network communication, and a flow measurement housing encapsulating the components of the utility measurement device. The assembly further includes a communication endpoint including a communication endpoint power source, communication endpoint electronics, a communication endpoint transceiver configured for both of local area network communication and wide area network communication, and a communication endpoint housing encapsulating the components of the communication endpoint. The assembly is configured wherein interaction between the utility measurement device and the communication endpoint is exclusively radio communication using the local area network.

In another more detailed aspect, the exclusive physical connection through the flow measurement housing connects to a conduit transporting a flow to be measured by the flow measurement electronics.

In another more detailed aspect, the communication endpoint housing encapsulates the components of the communication endpoint and is removable from the flow measurement housing. In another more detailed aspect, the flow measurement housing is configured to provide a connection point for a physical attachment of the communication endpoint housing.

In another more detailed aspect, the physical attachment is configured to position the communication endpoint housing relative to the flow measurement housing to optimize wireless communication between the communication endpoint electronics and the flow measurement electronics. In an alternative embodiment, the physical attachment is configured to position the communication endpoint housing relative to the flow measurement housing to optimize an inductive connection between the communication endpoint electronics and the flow measurement electronics.

In another more detailed aspect, the flow measurement electronics are configured to calibrate the communication endpoint electronics based on physical attachment of the flow measurement housing to the communication endpoint housing. In another more detailed aspect, the communication endpoint is configured for physical connection and wireless communication with a plurality of types of battery-operated utility measurement devices.

In another exemplary embodiment of the invention, utility meter communication endpoint is provided that includes a communication endpoint battery, communication endpoint electronics, a communication endpoint transceiver configured for both of local area network communication and wide area network communication, and a communication endpoint housing encapsulating the components of the communication endpoint and including a connection attachment point for physically connecting the connection endpoint housing to a flow measurement housing encapsulating utility measurement electronics. The communication endpoint is configured such that interaction between the utility measurement electronics and the communication endpoint electronics is exclusively radio communication using the local area network.

Other aspects of the invention, besides those discussed above, will be apparent to those of ordinary skill in the art from the description of the preferred embodiments which follows. In the description, reference is made to the accompanying drawings, which form a part hereof, and which illustrate examples of the invention.

### BRIEF DESCRIPTION OF THE DRAWINGS

FIG. 1 is representation of a utility meter including a metrology unit that is physically connected in an isolation arrangement with an associated communication endpoint, such that each of the metrology unit and the communication endpoint are in separate housings without physical connection between components in separate housing, according to an exemplary embodiment;

FIG. 2 is a perspective view of an exemplary implementation of the utility meter including a metrology unit that is connected in an isolation arrangement with an associated communication endpoint, according to an exemplary embodiment;

FIG. 3 is a perspective view of an exemplary implementation of the utility meter including a metrology unit that is connected in an isolation arrangement but physically connected with an associated communication endpoint, according to an exemplary embodiment;

FIG. 4 is an illustrative representation of an operating environment using the utility metering system of FIG. 1, according to an exemplary embodiment;

FIG. 5 is an alternative illustrative representation of an operating environment using the utility metering system of FIG. 1, according to an exemplary embodiment;

FIG. 6 is an alternative illustrative representation of an operating environment using the utility metering system of FIG. 1, according to an exemplary embodiment;

FIG. 7 is an alternative illustrative representation of an operating environment using the utility metering system of FIG. 1, according to an exemplary embodiment;

FIG. 8 is an alternative illustrative representation of an operating environment using the utility metering system of FIG. 1, according to an exemplary embodiment;

FIG. 9 is an alternative illustrative representation of an operating environment using the utility metering system of FIG. 1, according to an exemplary embodiment;

FIG. 10 is an alternative illustrative representation of an operating environment using the utility metering system of FIG. 1, according to an exemplary embodiment;

FIG. 11 is an alternative illustrative representation of an operating environment using the utility metering system of FIG. 1, according to an exemplary embodiment;

FIG. 12 is an alternative illustrative representation of an operating environment using the utility metering system of FIG. 1, according to an exemplary embodiment; and

FIG. 13 is an alternative illustrative representation of an operating environment using the utility metering system of FIG. 1, according to an exemplary embodiment.

### DETAILED DESCRIPTION OF THE INVENTION

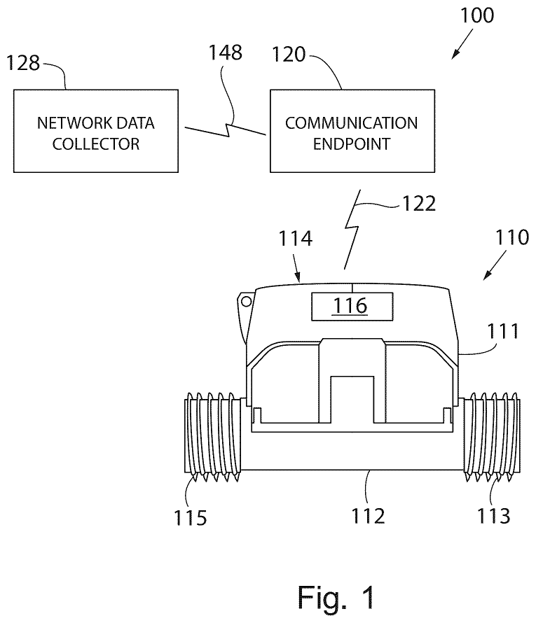

FIG. 1 is a representation of an electronic utility meter assembly 100 including an electronic utility meter 110 that is communicatively connected in an isolation arrangement with an associated communication endpoint 120, according to an exemplary embodiment. Electronic utility meter 110 is configured to measure utility use, such as in a gas meter or a water meter, etc. For simplicity, electronic utility meter 110 will be shown and referenced herein as being an ultrasonic water meter measuring fluid flow through a conduit 112.

Electronic utility meter 110 includes a meter housing 111, a conduit 112 having an upstream spud end 113 and a downstream spud end 115. The spud ends 113, 115 of the conduit 112, although shown as threaded pipe ends, can be replaced by coupling flanges in larger sized meters and/or other attachment means. Meter housing 111 may be configured to be encapsulated, weatherproof and UV-resistant. The meter housing 111 includes a display 114 that may be configured as a 9-digit LCD display for displaying a measured rate of flow, a reverse-flow indication, alarms, etc. to complete the enclosure as is known in the art. Meter housing 114 further includes one or more batteries (not shown) for driving the rate of flow measurement, the display, the transmitter providing communication from the housing, etc.

Electronic utility meter 110 may be configured with a solid state, ultrasonic measurement system 116 or metrology unit. As water flows into the measuring tube, conduit 112, through the upstream spud end 113, ultrasonic signals are sent consecutively in forward and reverse directions of flow prior to the water exiting the conduit 112 through downstream spud end 115. Velocity, or flow rate, of the water is then determined by measuring the time difference between the measurement in the forward and reverse directions. Total flow volume may then be calculated from the measured flow velocity, which may be further adjusted using, for example, water temperature, pipe diameter, etc. The LCD display 114 shows measured and or calculated information such as the total volume, alarm conditions, rate of flow, etc.

Although not shown, additional elements and electronic components of the ultrasonic measurement system 116 are positioned within the conduit 112, such as a polymer and/or stainless steel metering insert and transducers generating and receiving the ultrasonic signals. The metering insert may hold and orient ultrasonic reflectors in a variety of configurations facilitating minimally turbulent or non-turbulent water flow through conduit 112 and around the transducers and the ultrasonic signal reflectors themselves.

The measured and calculated values, including the flow value, may be configured to facilitate the measurement of or provide units of consumption of water. The values may be transmitted in binary, and be coded or encrypted or both. These signals 122 are transmitted in a Wireless Local Area Network (WLAN) signal to communication endpoint 120. Signals 122 may be, for example, short-range radio transmission that use ultra-high frequency (UHF) Bluetooth signals in the 2.4 GHz ISM spectrum band.

Communication endpoint 120 includes a radio transceiver in an isolation arrangement such that the transceiver is housed in the case of a separate assembly. The isolation arrangement is such that each of the housings for electronic utility meter 110 and communication endpoint 120 may be configured to be sealed and isolated from one another such that communication is exclusively through electronic signals and/or emissions. The housings may be further configured without ports and/or other openings that may provide points of failure for the housing encapsulation of the interior electronics within each housing. The radio transceiver at endpoint 120 includes a radio transmitter portion and a radio receiver portion. The radio transmitter portion converts the measurement system signals 122, received through the radio receiver portion, to a radio frequency signaling protocol for transmission back to a network data collector 128 through a wireless wide area network (WWAN) wireless network.

Although this embodiment includes an electronic type of meter register, it should be understood that the invention can be practiced with other types of meter such as electromechanical types of meter registers. Although an ultrasonic type water meter 110 is shown and described, the invention in its broadest scope can also be applied to other types of water meters, including turbine type, mag meters and disc-type meters. Electronic utility meter 110 is configured to include both the ultrasonic water meter housing 111 and conduit 112 inclusive to the lay length of a standard water meter such that additional retrofits to install the meter aren't required in an exemplary embodiment.

Advantageously, water meter assembly 100 provides a short-range wireless radio (WLAN) communication between the metrology unit in an electronic utility meter and an external long range radio communication unit (WWAN) designed to be physically attached to the electronic utility meter. Additionally, this communication can be used for other uses, such as test of the measurement system 116, connection to close-by mobile devices (such as cell phone), etc. Providing a separate water meter 110 and communication endpoint 120 delays the choice of meter size in production until the very last second before the final test and calibration. In other words, all units (electronic utility meters and communication endpoints) can be on stock and then be assembled at the time of a sales order, for example.

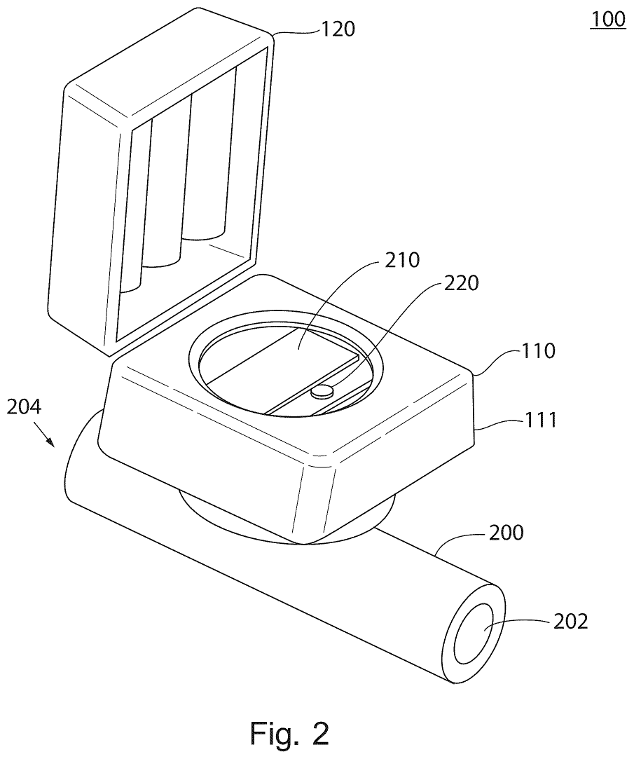

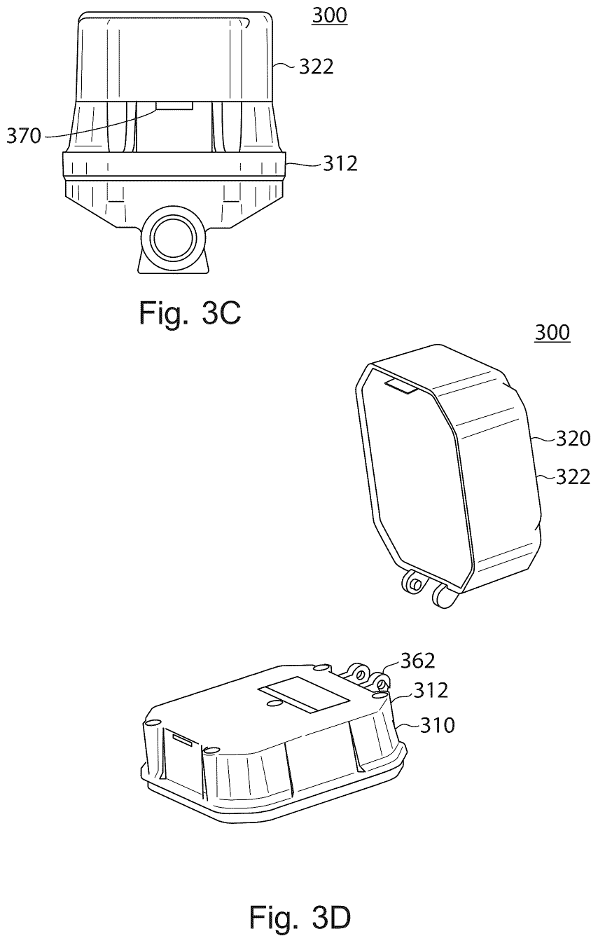

Referring now to FIG. 2, a perspective view of an exemplary implementation of the utility metering system 100 including a metrology unit (ultrasonic water meter 110) that is connected in an isolation arrangement with an associated communication endpoint 120, according to an exemplary embodiment. Ultrasonic water meter 110 includes a meter housing 111 and a conduit 200 having an upstream end 202 and a downstream end 204. Meter housing 111 is configured to be encapsulated, weatherproof and UV-resistant such that the only external connection from the meter housing 111 is between the ultrasonic water meter 110 and conduit 200 as shown and described below with reference to FIG. 4. The meter housing 111 includes a display 210 for displaying information from the water meter 110. Meter housing 111 further includes button 220 allowing direct communication and/or interaction with the water meter 110, such as through a capacitive touch switch. The meter housing may further include additional input means, such as an infrared (IR) port.

Communication endpoint 120 is also encapsulated, weatherproof and UV-resistant. However, endpoint 120 is configured such that the only external connection is through wireless transmissions, such as with water meter 110 and/or the remote network data collector 128 for example.

Water meter 110 and communication endpoint 120 are each configured to include independent power supplies, electronics, radio transceivers, etc. configured to perform their associated functionality as is known in the art and described herein. The radio transceiver for the water meter 110 is configured for WLAN communication, such as by using Bluetooth signals. The one or more radio transceivers for the communication endpoint 120 is configured for both WLAN communication, such as by using Bluetooth signals and WWAN network, such as by using long term evolution (LTE) or wireless meter bus (WMBus) protocols.

Although water meter 110 is described as being encapsulated and isolated from physical connection with communication endpoint 120, water meter 110 may be configured for physical connections other than with communication endpoint 120. For example, the water meter 110 may provide electrical connections penetrating the housing 111—for ultrasonic transducers, pressure sensors etc.

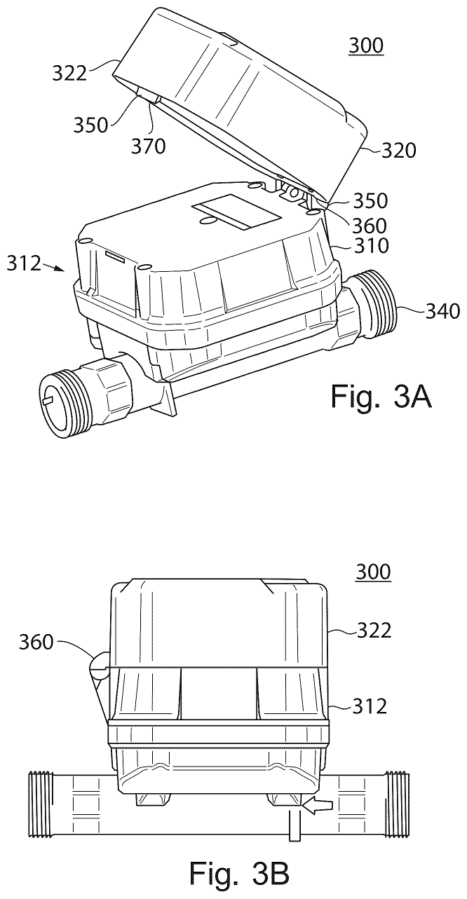

Referring now to FIG. 3A, a perspective view of an exemplary implementation of a utility metering system 300 including an electronic utility meter (ultrasonic water meter 310) configured for a physical connection but still in an isolation arrangement with an associated communication endpoint 320, according to an exemplary embodiment. In the embodiment shown, both the housings of ultrasonic water meter 310 and communication endpoint 320 are configured to secure and position the housing relative to one another.

In this embodiment, ultrasonic water meter 310 includes a water meter housing 312 on a conduit 340 and communication endpoint 320 includes a communication endpoint housing 322 that are configured to allow utility metering system 300 to be assembled and secured using a physical connection point 350 that requires no screws, such as springs/clicks on the inside of a protective shield.

Connection point 350 is configured to secure water meter housing 312 to communication endpoint housing 322 such that the housings are attached and positioned proximate to each other to facilitate wireless communication therebetween based on previous configuration of the components. For example, the ultrasonic water meter 310 and the communication endpoint 320 may be configured to recognize each other and pair the WLAN radio communication at the time of physical connection. Connection point 350, in the embodiment shown, is configured to include a hinge portion 360 and a latch portion 3370. Hinge portion 360 and latch portion 370 are configured such that each portion includes components on both of water meter housing 312 and communication endpoint housing 322. Both hinge portion 360 and latch portion 370 are configured to be external features of their respective housings such that each housing remains encapsulated and weatherproof.

Referring now to FIG. 3B, a side view of the exemplary implementation of the utility metering system 300 of FIG. 3A is shown in a closed position, according to an exemplary embodiment. In the embodiment shown, both the housings of ultrasonic water meter 310 and communication endpoint 320 are configured to secure and position the housing relative to one another by the hinge portion 360.

Referring now to FIG. 3C, an end view of the exemplary implementation of the utility metering system 300 of FIG. 3A is shown in a closed position, according to an exemplary embodiment. In the embodiment shown, both the housings of ultrasonic water meter 310 and communication endpoint 320 are configured to secure and position the housing relative to one another by the latch portion 370.

According to an exemplary embodiment, the hinge portion 360 and the latch portion 370 may be configured to facilitate both connection and relative positioning of the ultrasonic water meter 310 and communication endpoint 320 and easy separation of these components. For example, hinge portion 360 may be configured to include one or more removable pins (not shown) that allows easy separation of the hinge portion 360 into separate portions affixed to water meter housing 312 and communication endpoint housing 322. Following removal of the removable pins, the separate portions of latch portion 370 affixed to water meter housing 312 and communication endpoint housing 322 may be similarly easily separated.

Referring now to FIG. 3D, a perspective view of the exemplary implementation of the utility metering system 300 of FIG. 3A is shown in an open position and separated configuration, according to an exemplary embodiment. In the embodiment shown, both the housings of ultrasonic water meter 310 and communication endpoint 320 are physically separated from one another despite being configured to maintain a wireless communication link. As shown, a lower portion 362 of hinge portion 360 is incorporated into the water meter housing 312 and an upper portion 364 of hinge portion 360 is incorporated into the communication endpoint housing 322. Similarly, a lower portion 372 of latch portion 370, specifically the latch receiver, is incorporated into the water meter housing 312 and an upper portion 374 of latch portion 370, specifically the latch, is incorporated into the communication endpoint housing 322.

Advantageously, configuring electronic utility meter 300 such that of ultrasonic water meter 310 and communication endpoint 320 are connectable in a specific alignment and separable as needed improves the function and flexibility of the electronic utility meter 300. For example, electronic utility meter 300 in its connected state may be configured to optimize wireless interaction between ultrasonic water meter 310 and communication endpoint 320 while electronic utility meter 300 in its separated state facilitates component replacement and use flexibility as further discussed below with reference to FIGS. 4-XXX. Providing a short-range wireless radio communication between the metrology unit of a water meter and an external long range radio communication unit using a communication endpoint designed to be physically attached to the metrology unit allows additional advantages by allowing the endpoint to be physically separated from the metrology unit while remaining within the range of the local area network and the wide area network in a variety of configurations.

Referring now to FIG. 4, an illustrative representation of an operating environment 400 using a utility metering system including a water meter 410 that is in an isolation arrangement and physically attached to an associated communication endpoint 420 in communication with a network data collector through a wide area network 430, according to an exemplary embodiment. The network data collector may be, for example, a component of an automated meter reading (AMR) system and/or an advanced metering infrastructure (AMI). Operating environment 400 is provided as an illustration and one or ordinary skill in the art would understand that the number of components, components and/or configuration of components will vary with intended use.

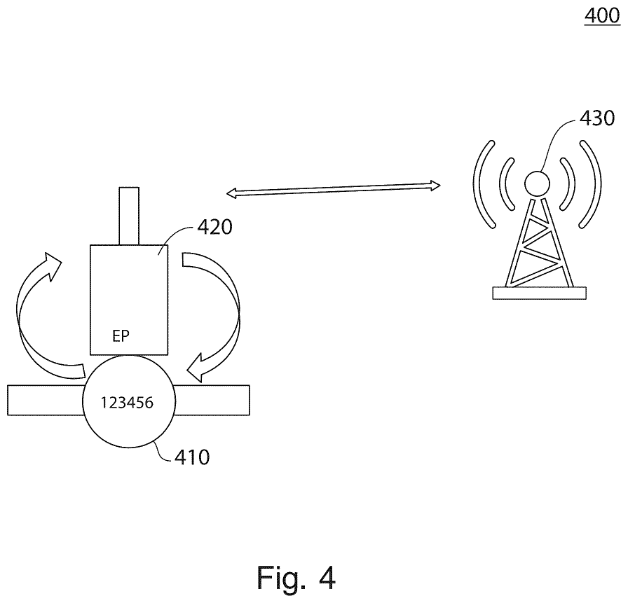

Referring now to FIG. 5, an illustrative representation of an operating environment 500 using a utility metering system including a water meter 510 that is in an isolation arrangement and physically separated from an associated communication endpoint 520 in communication with a network data collector through a wide area network 530, according to an exemplary embodiment. The network data collector may be, for example, a component of an automated meter reading (AMR) system and/or an advanced metering infrastructure (AMI). Operating environment 500 is provided as an illustration and one or ordinary skill in the art would understand that the number of components, components and/or configuration of components will vary with intended use.

Automated meter reading is the communication technology water utilities use to automatically collect water consumption and status data from water meters. AMR systems can be either walk-by or drive-by. An endpoint is connected to the meter's encoder register for a water meter including a metrology unit measuring water flow. The endpoint receives the measured water flow and alarm data which is collected by utility personnel by walking or driving by with a data receiver in proximity to the device. After collection, the meter data is transferred to a database where utilities can monitor and analyze usage, troubleshoot issues and bill customers based on actual consumption, rather than predictions that were often required with bi-monthly or quarterly manual reads.

Advanced metering infrastructure is an integrated system of water meters, communication networks and data management systems that enables two-way communication between meter endpoints and utilities. Unlike AMR, AMI doesn't require utility personnel to collect the data. Instead, the system automatically transmits the data directly to the utility at predetermined intervals. Meter data is sent to utilities via a fixed network, such as wide area network 530. The utility can use the data to improve operational efficiencies and sustainability by effectively monitoring water usage and system efficiency, detecting malfunctions and recognizing irregularities.

With a fixed network, utilities work with specific vendors to get their infrastructure and technologies up and running. And today, existing cellular networks, designed to minimize downtime, can be used to make sure meter data is collected securely and without interruption.

Advantageously, the present invention may be used to optimize communication to and from communication endpoint 520 with both water meter 510 and wide area network 530. During installation, water meter 510 may be physically coupled with communication endpoint 520 to provide an optimal meter communication connection 515 for installation and calibration. Following installation, the communication endpoint 520 linked to wide are network 530 to determine the quality of the wide area communication connection 525. Thereafter, communication endpoint 520 may be physically decoupled from the water meter and relocated to optimize both meter communication connection 515 and wide area communication connection 525. Communication optimization may be provided using one or more different methods, such as a display on a mobile device, a display on the endpoint, communication with a remote computer system, etc.

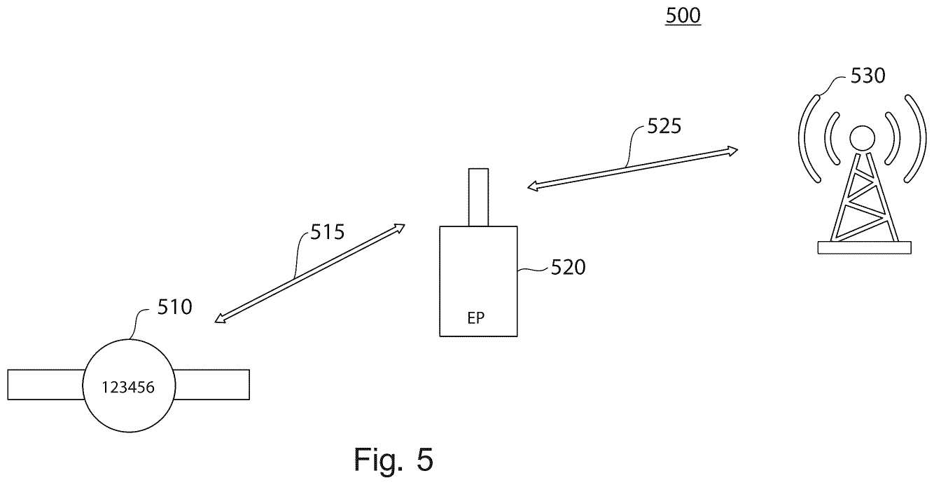

Referring now to FIG. 6, an illustrative representation of an alternative operating environment 600 using a utility metering system including a water meter 610 that is physically separated from an associated communication endpoint 620 in communication with a network data collector through a wide area network 630, according to an exemplary embodiment. Operating environment 600 is provided as an illustration and one or ordinary skill in the art would understand that the number of components, components and/or configuration of components will vary with intended use.

In the embodiment shown, communication endpoint 620 is configured to include an actuator communication connection 635 linking the communication endpoint to one or more actuators 640. Similar to FIG. 5, communication endpoint 620 may be physically decoupled from the water meter 610 and relocated to optimize actuator communication connection 635 without interfering with meter communication connection 615 and/or wide area communication connection 625. Actuator 640 may be, for example, a shutoff valve configured to shut off provision of the utility based on a variety of circumstances such as detected flooding, an earthquake requiring gas shutoff, etc.

Communication endpoint 620 is further configured to include a sensor communication connection 645 linking the communication endpoint to one or more sensors 650. Communication endpoint 620 may be additionally relocated to optimize sensor communication connection 645. Sensor 650 may be, for example, a pressure sensor, a flood sensor, etc.

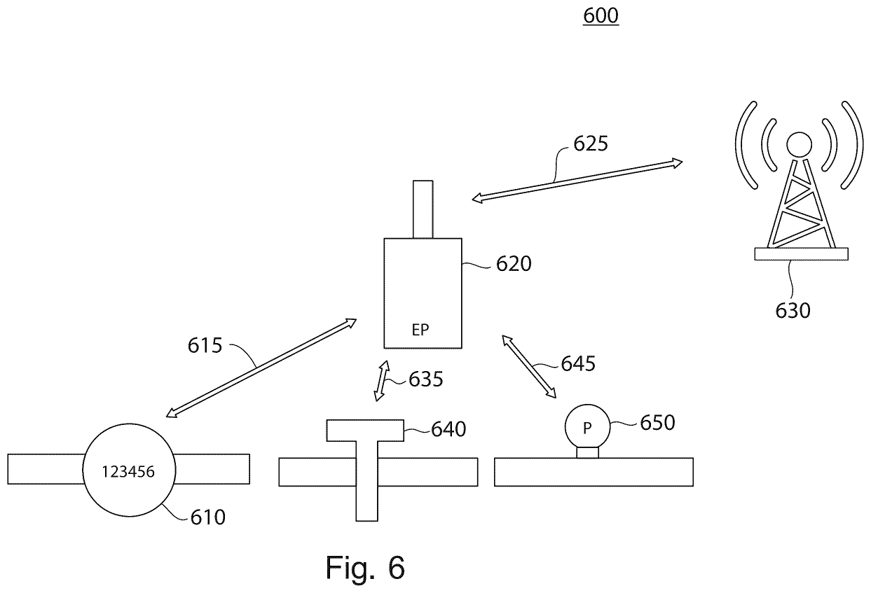

Referring now to FIG. 7, an illustrative representation of an alternative operating environment 700 using a utility metering system including a water meter 710 that is physically separated from an associated communication endpoint 720 in communication with a network data collector through a wide area network 730, according to an exemplary embodiment. Operating environment 700 illustrates a communication endpoint 720 configured to include a meter interface unit 722 connected by wired communication connection 724 to endpoint 720. Operating environment 700 is provided as an illustration and one or ordinary skill in the art would understand that the number of components, components and/or configuration of components will vary with intended use.

Advantageously, a communication endpoint 720 configured to include a wired connection 724 to a meter interface unit 722 may provide the advantages described herein for additional use cases. In such use cases, the meter interface unit 722 may be configured for physical coupling to the water meter 710 to optimize wireless communication therewith. Thereafter, the meter interface unit 722 may be optionally separable from the water meter 710. For example, it may be advantageous to physically couple the meter interface unit 722 to the water meter 710 in a pit enclosure that is prone to flooding while allowing physical separation of the communication endpoint 720 to optimize communication with the wide area network 730 and still allowing for easy replacement and upgrading of both the meter interface unit 722 and communication connection 724 as needed.

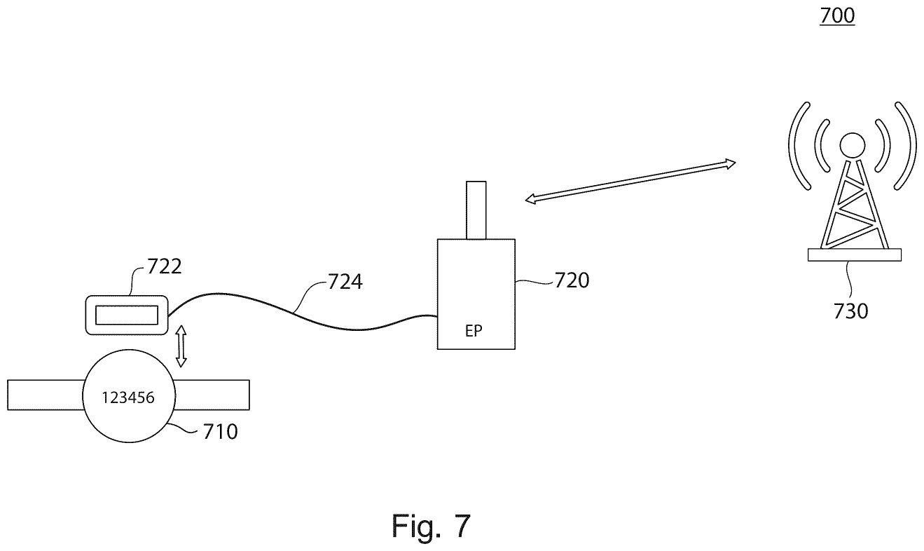

Referring now to FIG. 8, an illustrative representation of an alternative operating environment 800 using a utility metering system including a water meter 810 that is physically separated from an associated communication endpoint 820 in communication with a network data collector through a wide area network 830, according to an exemplary embodiment. Operating environment 800 illustrates a communication endpoint 820 configured to two additional communication connections 835 and 845 providing communication with additional utility meters 840 and 850, respectively. Operating environment 800 is provided as an illustration and one or ordinary skill in the art would understand that the number of components, components and/or configuration of components will vary with intended use.

Advantageously, a physically displaceable communication endpoint 820 configured to implement communication connections with more than one utility meter can improve the flexibility and robustness of an automated metering infrastructure. For example, where multiple utility meters 810, 840 and 850 are provided in proximity such as in an apartment building or adjacent townhouses, the communication connection to all utility meters may be provided and optimized for all utility meter following physical connection and calibration with each utility meter. Alternatively, additional communication channels may be established based on a detected failure of endpoints associated with the additional utility meters 840 and 850.

Advantageously, a physically displaceable communication endpoint 820 configured to implement communication connections with more than one utility meter can improve the flexibility and robustness of an automated metering infrastructure. For example, where multiple utility meters 810, 840 and 850 are provided in proximity such as in an apartment building or adjacent townhouses, the communication connection to all utility meters may be provided and optimized for all utility meter following physical connection and calibration with each utility meter. Alternatively, additional communication channels may be established based on a detected failure of endpoints associated with the additional utility meters 840 and 850.

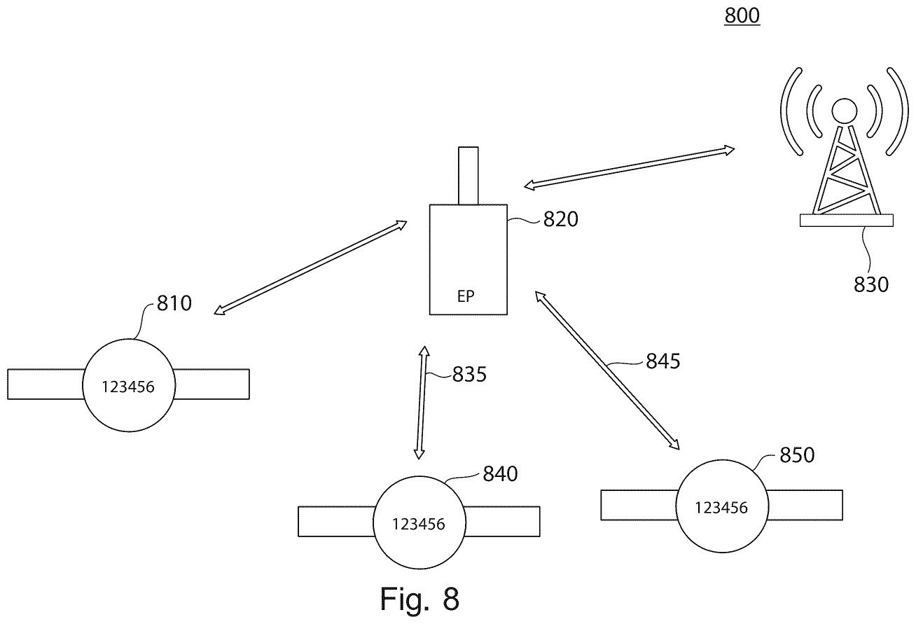

Referring now to FIG. 9, an illustrative representation of an alternative operating environment 900 using a utility metering system including a plurality of water meters 910-916 that are physically separated from an associated communication endpoint 920 in communication with a network data collector through a wide area network 930, according to an exemplary embodiment. Operating environment 900 illustrates a communication endpoint 920 configured to provide communications with the plurality of water meters 910-916 through their respective WLAN communication links. In the embodiment shown, the plurality of water meters 910-916 communicate through their respective WLAN communication links in a daisy chain communication chain. Operating environment 900 is provided as an illustration and one or ordinary skill in the art would understand that the number of components, components and/or configuration of components will vary with intended use.

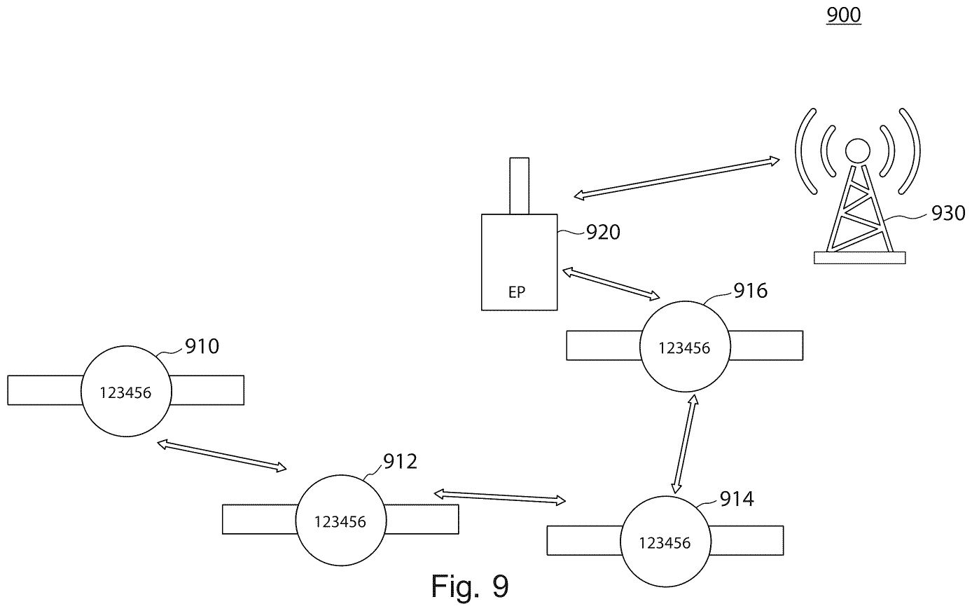

Referring now to FIG. 10, an illustrative representation of an alternative operating environment 1000 using a utility metering system including water meter 1010 that is separated from or is associated with a unavailable communication endpoint (not shown), according to an exemplary embodiment. Operating environment 1000 illustrates a water meter 1010 configured to provide alternative communication through its WLAN communication link with a remote computing device 1020, such as the mobile communication device shown. The mobile computing device may act to configure the water meter 1010, to exchange information such as meter readings when a communication endpoint has failed or run out of batteries, to act as connection point to a wide area network, etc. The mobile computing device may further act to exchange information such as meter readings to normal operating conditions for use with customer applications installed on the mobile device such as for tracking utility usage, efficiency, current billing rates, etc. The mobile computing device may further be used for debugging, updating, etc. the utility meter 1010 and/or a communication endpoint (not shown).

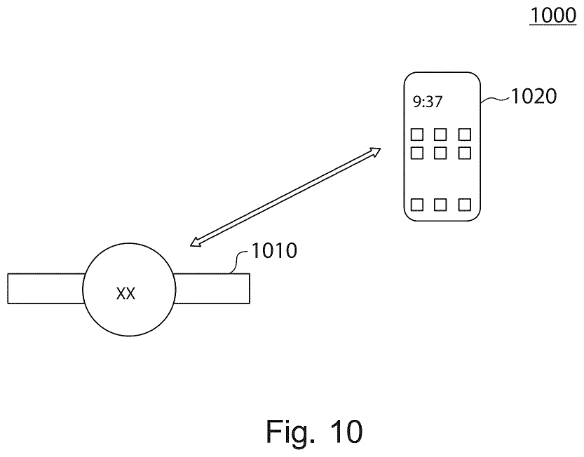

Referring now to FIG. 11, an illustrative representation of an alternative operating environment 1100 using a utility metering system including water meter 1110 that is in an isolation arrangement and physically attached to an associated communication endpoint 1120 in communication with a network data collector through a wide area network 1130, according to an exemplary embodiment. Operating environment 1100 illustrates a system configured to facilitate installation and configuration of the water meter 1110 and the communication endpoint 1120 through a remote computing device 1140, such as the mobile communication device shown.

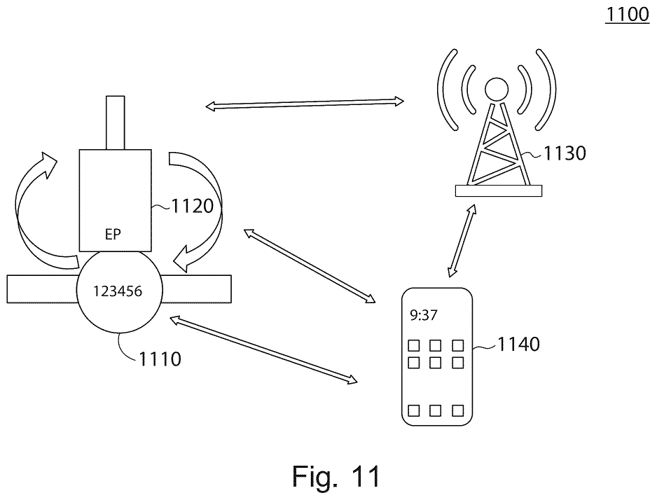

Referring now to FIG. 12, an illustrative representation of an alternative operating environment 1200 using a utility metering system including a plurality of water meters 1210-1216 that are physically separated from an automatic meter testing system 1220 configured for remote systems testing and management. Operating environment 1200 is provided as an illustration and one or ordinary skill in the art would understand that the number of components, components and/or configuration of components will vary with intended use.

Referring now to FIG. 12, an illustrative representation of an alternative operating environment 1200 using a utility metering system including a plurality of water meters 1210-1216 that are physically separated from an active management technology (AMT) system 1220 configured for hardware-based remote systems management. Operating environment 1200 is provided as an illustration and one or ordinary skill in the art would understand that the number of components, components and/or configuration of components will vary with intended use.

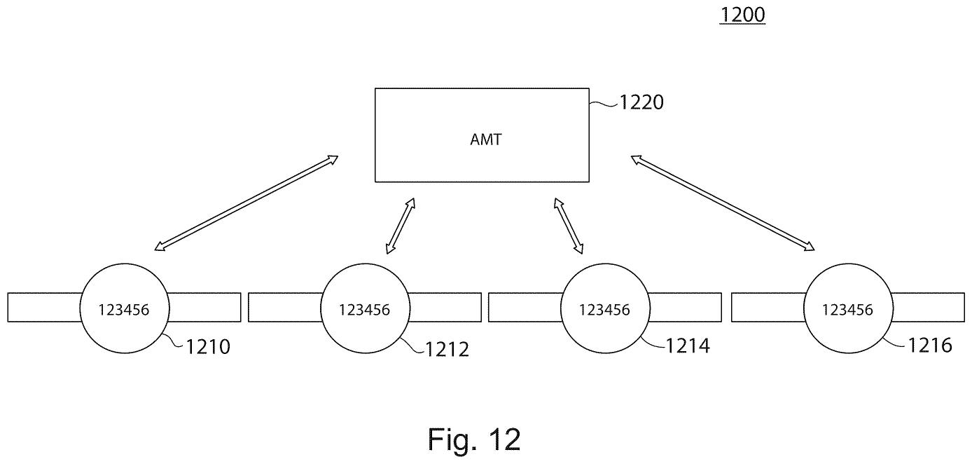

Referring now to FIG. 13, an illustrative representation of an alternative operating environment 1300 using a utility metering system including water meters 1310-1312 that are separated from associated communication endpoints 1320-1322 and in communication with a remote computing device 1330. The mobile computing device 1330. may be configured to implement a digital product passport configured to implement a digital record of the components' lifecycle, including, for example, their respective materials, environmental impact, disposal guidelines, etc.

This has been a description of the preferred embodiments, but it will be apparent to those of ordinary skill in the art that variations may be made in the details of these specific embodiments without departing from the scope and spirit of the present invention, and that such variations are intended to be encompassed by the following claims.

We claim:

1. A utility meter assembly, comprising:
a battery-operated utility measurement device providing measurement of the utility provided including
a flow measurement battery,
flow measurement electronics,
a flow measurement transceiver configured for a local area network communication, and
a flow measurement housing encapsulating the components of the utility measurement device; and
a communication endpoint including
a communication endpoint battery,
communication endpoint electronics,
a communication endpoint transceiver configured for both of local area network communication and wide area network communication, and
a communication endpoint housing encapsulating the components of the communication endpoint,
wherein interaction between the flow measurement electronics and the communication endpoint electronics is exclusively radio communication using the local area network.

2. The utility meter assembly of claim 1, wherein the exclusive physical connection through the flow measurement housing connects to a conduit transporting a flow to be measured by the flow measurement electronics.

3. The utility meter assembly of claim 1, wherein the communication endpoint housing encapsulates the communication endpoint electronics and is removable from the flow measurement housing.

4. The utility meter assembly of claim 1, wherein the flow measurement housing is configured to provide a connection point for a physical attachment of the communication endpoint housing.

5. The utility meter assembly of claim 4, wherein the physical attachment is configured to position the communication endpoint housing relative to the flow measurement housing to optimize wireless communication between the communication endpoint electronics and the flow measurement electronics.

6. The utility meter assembly of claim 4, wherein the flow measurement electronics are configured to calibrate the communication endpoint electronics based on physical attachment of the flow measurement housing to the communication endpoint housing.

7. The utility meter assembly of claim 1, wherein the communication endpoint is configured for physical connection and wireless communication with a plurality of types of battery-operated utility measurement devices.

8. A utility meter communication endpoint, comprising:
a communication endpoint battery,
communication endpoint electronics,
a communication endpoint transceiver configured for both of local area network communication and wide area network communication, and
a communication endpoint housing encapsulating the components of the communication endpoint and including a connection attachment point for physically connecting the connection endpoint housing to a flow measurement housing encapsulating utility measurement electronics,
wherein interaction between the utility measurement electronics and the communication endpoint electronics is exclusively radio communication using the local area network.

9. The utility meter communication endpoint of claim 8, wherein the communication endpoint housing encapsulates the communication endpoint electronics and is removable from the flow measurement housing.

10. The utility meter communication endpoint of claim 8, wherein the physical attachment is configured to position the communication endpoint housing relative to the flow measurement housing to optimize wireless communication between the communication endpoint electronics and the flow measurement electronics.

11. The utility meter communication endpoint of claim 8, wherein the flow measurement electronics are configured to calibrate the communication endpoint electronics based on physical attachment of the flow measurement housing to the communication housing.

12. The utility meter communication endpoint of claim 8, wherein the communication endpoint is configured for physical connection and wireless communication with a plurality of types of battery-operated utility measurement devices.
